(19) United States
(12) Patent Application Publication
(10) Pub. No.: US 2018/0098909 A1
(43) Pub. Date: Apr. 12, 2018

(54) METHOD AND DEVICE FOR ACTING ON THE SKIN OF A LIVING BEING AND METHOD FOR COMBATTING SKIN CHANGES (VARIANTS)

(71) Applicant: Alexei Dmitrievich BARABASH, Chuguev (UA)

(72) Inventor: Alexei Dmitrievich BARABASH, Chuguev (UA)

(21) Appl. No.: 15/561,296

(22) PCT Filed: Mar. 24, 2015
(86) PCT No.: PCT/IB2015/000401

§ 371 Date: Nov. 15, 2017

(51) Int. Cl. A61H 7/00; A61H 15/00

(52) U.S. Cl. CPC A61H 7/001; A61H 11/00; A61H 15/00; A61H 7/006

(57) ABSTRACT

The invention relates to a medicine and cosmetology. The use thereof allows for widening the inventory of technical means and obtain universal and simple means for acting on skin integument of living being. A method for acting on skin integument of living being is implemented using a device for acting on skin integument of living being, which device comprising discrete elements fixed at the inside surface of patch intended for creating, at respective areas of the skin integument, the constant pressure ensuring an anematization and deformation of those areas of the skin integument during a predetermined time period, herewith the form, size and surface texture of each of the discrete elements butted against a specific area of the skin integument, as well as a distance between the discrete elements being selected depending on the action required for that specific area of the skin integument, and the predetermined time period and a force of the constant pressure being determined depending on both the specific area of the skin integument and the action required for that area of the skin integument.

### FIELD OF THE INVENTION

The present invention relates to a medicine and cosmetology, in particular, to a method for acting on skin integument of living being and device for performing this method, and to various methods for combating skin changes.

### BACKGROUND OF THE INVENTION

At present, various methods are used for acting on the skin integument by means of pressure, as well as devices for performing thereof. For example, the RU Patents Nos. 2174829 (publ. Oct. 20, 2001) and 2201193 (publ. Mar. 27, 2003) disclose massage methods by pressing movements adding an action of low electrical current on the skin integument of patient. Those methods are rather complicated in use.

Also known is a masseur (RU Patent Application No. 95104274, publ. Feb. 10, 1997) comprising a helmet within which is injected a compressed air or liquid, by which is produced a pressure onto the head skin of the patient putting on that helmet. It is clear that this masseur has a very limited use, especially due to the fact that it is necessary to use a special facility (a pump or compressed gas vessel) for creating the pressure.

In the RU Patent No. 1497796 (publ. Jul. 20, 1996) is described a method of the alopecia treatment by means of applying a pressure onto the head skin by needles mounted within a helmet that is put on the patient head. This method has also a limited use and furthermore provides for pricking the skin, and the following action could be realized only after repairing those hurts, which could be unacceptable for the patient.

As the closest analog, a method for massaging the human or animal body could be considered, which method is carried out by a device in accordance with the U.S. Patent Application No. 2013/0245507 (publ. Aug. 19, 2013). In that device, a hollow chamber is provided at the end of actuator, which chamber is destined for applying onto a skin area for the air suction, and within that chamber are mounted protruding elements making a constant pressure onto the skin, which pressure is registered by a respective sensor at the actuator. A disadvantage of this device having a limited use consists also in its complexity and unwieldiness.

### SUMMARY OF THE INVENTION

Thus, the object of the present invention consists in widening the inventory of technical means by developing such a method for acting on skin integument of living being for anematization and deformation thereof during a predetermined time period, and device for carrying out that method, which method and device would be simple in use and at the same time sufficiently universal.

In order to solve that problem and achieve said technical result, the first object of the present invention provides a method for acting on skin integument of living being, which method comprising a step of applying a constant pressure onto respective areas of the skin integument using discrete elements, and that constant pressure ensuring an anematization and deformation of the areas of the skin integument during a predetermined time period, herewith the form, size and surface texture of each of the discrete elements butted against a specific area of the skin integument, as well as a distance between the discrete elements being selected depending on the action required for that specific area, and the predetermined time period and a constant pressure force being determined depending on both the specific area of the skin integument and the action required for that area.

A peculiarity of the method according to the present invention consists in that as the discrete elements could be used elements made from a material selected from the group including metals, wood, plastics, silicon, rubber, organic or inorganic minerals.

One more peculiarity of the method according to the present invention consists in that the constant pressure could be applied using means selected from the group including a headdress; a mask applied onto a face; a band applied onto a respective body part; at least one detail of a compression suit put on respective body part. Herewith, as the detail of the compression suit could be used a thing selected from the group including a shirt, trousers, gloves, sleevelets.

In order to solve the same problem and achieve the same technical result, the second object of the present invention provides a device for acting on skin integument of living being, which device comprising discrete elements fixed at the inside surface of patch intended for creating, at respective areas of skin integument, the constant pressure ensuring an anematization and deformation of the areas of the skin integument during a predetermined time period, herewith the form, size and surface texture of each of the discrete elements butted against a specific area of the skin integument, as well as a distance between the discrete elements being selected depending on the action required for that specific area, and the predetermined time period and a constant pressure force being determined depending on both the specific area of the skin integument and the action required for that area.

A peculiarity of the device according to the present invention consists in that as the discrete elements could be used elements made from a material selected from the group including metals, wood, plastics, silicon, rubber, organic or inorganic minerals.

One more peculiarity of the device according to the present invention consists in that the constant pressure could be applied using means selected from the group including a headdress; a mask applied onto a face; a band applied onto a respective body part; at least one detail of a compression suit put on respective body part. Herewith, as the detail of the compression suit could be used a thing selected from the group including a shirt, trousers, gloves, sleevelets.

One more peculiarity of the device according to the present invention consists in that the patch could be made from elastic yarns tying the discrete elements each other, or from a compression knitted fabric, or from an elastic polymer with the discrete elements fixed thereon.

At last, one more peculiarity of the device according to the present invention consists in that the device could comprise additional discrete elements fixed on the outer surface of the patch.

In order to solve the same problem and achieve the same technical result, the third object of the present invention provides a method for combating the head skin alopecia, which method comprising a step of providing a constant anematization and deformation of the skin during the predetermined time period using the device in accordance with the second object of the present invention made in the form of headdress.

In order to solve the same problem and achieve the same technical result, the fourth object of the present invention provides a method for combating the age-related changes of facial skin, which method comprising a step of providing a constant anematization and deformation of the skin during the predetermined time period using the device in accordance with the second object of the present invention made in the form of mask applied onto the face.

In order to solve the same problem and achieve the same technical result, the fifth object of the present invention provides a method for combating the age-related changes of neck skin, which method comprising a step of providing a constant anematization and deformation of the skin during the predetermined time period using the device in accordance with the second object of the present invention made in the form of band applied onto the neck.

In order to solve the same problem and achieve the same technical result, the sixth object of the present invention provides a method for combating the lipodystrophical changes of thigh skin, which method comprising a step of providing a constant anematization and deformation of the skin during the pre-determined time period using the device in accordance with the second object of the present invention made in the form of trousers put on the thighs.

In order to solve the same problem and achieve the same technical result, the seventh object of the present invention provides a method for combating the age-related changes of hand/arm skin, which method comprising a step of providing a constant anematization and deformation of the skin during the pre-determined time period using the device in accordance with the second object of the present invention made in the form of gloves and/or sleevelets put on the arms/hands.

### BRIEF DESCRIPTION OF THE DRAWINGS

The present invention is illustrated with the enclosed drawings, in which the same or similar elements are marked with the same reference numbers.

FIG. 1 shows conditional view of discrete elements for using in the device according to the present invention.

FIGS. 2-4 show separate areas of various embodiments of the device according to the present invention.

FIG. 5 shows an embodiment of the device according to the present invention in the form of headdress.

### DETAILED DESCRIPTION OF EMBODIMENTS

In order for carrying out the device according to the present invention, it has been offered to use discrete elements made of any material. Such a material could be, for example, metal (silver, aluminium, etc.), wood, plastic, silicon, rubber, organic or inorganic minerals (e.g., amber, corals, pumice). Preferably, such material does not conduct air.

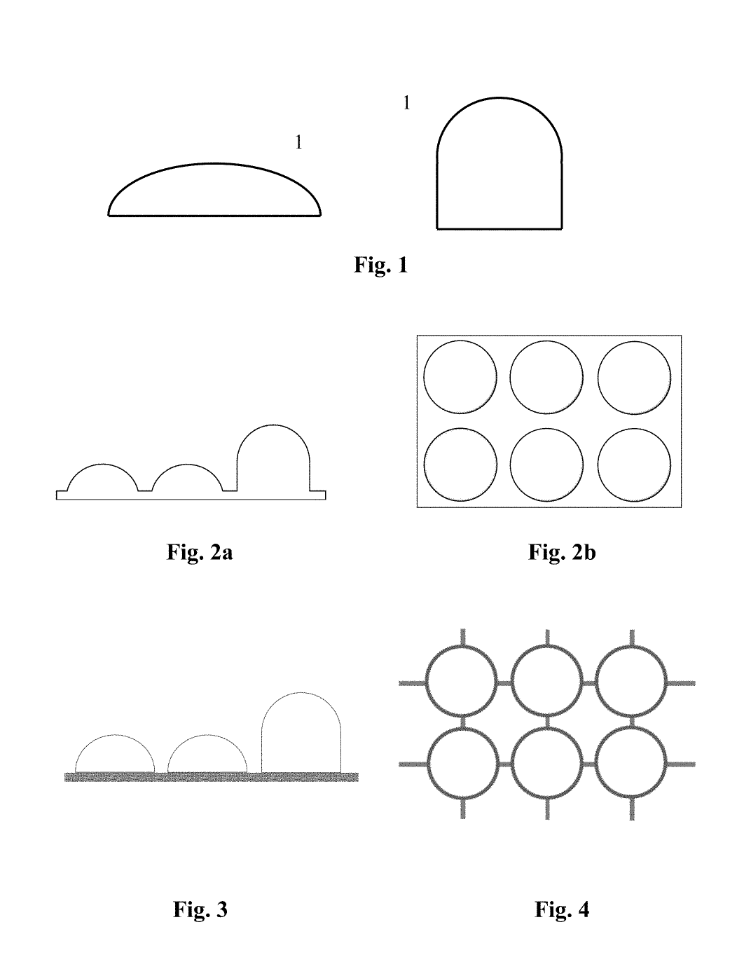

The discrete elements 1 could have a shape as shown in FIG. 1, i.e., they can appear as spherical segments or cylinders with a hemispherical top. However, such a form of the discrete elements is not the only possible, since they can have another form, for example, in the form of columns having a square or hexagonal cross-section with a beveled pyramidal top. The discrete elements could have also an elongated form, for example, a form of rollers or parallelepipeds. Sizes of the discrete elements could vary from deciles of millimeter (where the skin is delicate, for example, around eyes) to centimeters. All those forms and sizes, as well as a texture of the surface destined for contacting with a skin (smooth or ribbed, or having outgrowths in order for entering between hairs, or any other form) are selected depending on the action required for a specific area of the skin integument of respective human being or animal In the same way, the required action can determine a distance between separate discrete elements and a “pattern” of relative position thereof, for example, in the form of rectangular or hexagonal lattice, concentric circles, parallel rows, random distribution, etc. It is important to note that the discrete elements in accordance with the present invention are not needles for acupuncture designed for acting onto reflectory points, since they do not have pointed ends.

In order for providing the constant pressure onto the skin area, the discrete elements can be secured at a respective patch which is fixed on the indicated area of the skin integument by some means or other. Such a patch can be, for example, a compression band or a detail of compression suit, or several details, or even the whole compression suit like the aqualunger suit. This could be also a headdress, e.g., in the form of swimmer hattock, or mask put on a face.

Various techniques can be used for securing the discrete elements. For example, such discrete elements 1 can be molded from elastic material (e.g., form elastic plastic such as polyurethane, or from silicon) together with a substrate layer 2 (FIG. 2a). Then, a sector of such substrate layer 2 with the discrete elements 1 molded thereon (FIG. 2b) could be applied on respective skin area and fixed there by the compression band. Otherwise, the substrate layer 2 itself with the discrete elements 1 could serve as such compression band or detail of compression suit or headdress. In this case, the substrate layer 2 can be both continuous and in the form of net with the discrete elements 1 disposed in the nodes thereof.

In another embodiment, the discrete elements 1 are secured by glue at a knitted material 3 (FIG. 3), from which the compression band or detail of the compression suit is made. In one more embodiment, the discrete elements 1 are joined (connected) each other by elastic yarns 4 (FIG. 4), from which the patch is made. In this case, the fastening of the discrete elements 1 to the elastic yarns 4, or knitted fabric, or other material can be performed using an appropriate glue, or by clincher, or by any other technique, both known to those skilled in the art and newly developed one.

Naturally, these embodiments do not at all limited the present invention, and those skilled in the art could propose other embodiments in the scope of the present invention. Particularly, additional discrete elements can be fastened at the outer surface of the patch being in use, which will make such bilateral patch more functional.

It is understandable for those skilled in the art that in the device according to the present invention, the constant pressure onto the skin is achieved only by resilient-elastic features of the patch itself not requiring to use any additional means.

The method for acting on skin integument of living being in accordance with the present invention is implemented as follows.

The respective patches having the above discrete elements are placed onto individual areas of the skin integument requiring the pressurization. The pressure of the discrete elements of such patches onto the skin is created by compression bands (bandages, masks) or respective details (for example, sleeves, belt, foot/leg holders, collar, hattock) of the compression suit.

As a result, deformations (a plurality of alternate zones of compression and expansion) arise in the skin integument under the discrete elements pressed thereto with the predetermined force, and the anemization takes place (due to mechanical expulsion of blood from the skin and restriction of the skin blood flow). Such a condition lasts for a predetermined time period, minutes or hours, which have a medical, stimulative and prophylactic action onto those skin areas. The prophylactic effect is conditioned by that the anemizated skin and hair follicles are less sensitive to the action of ionization radiation and chemicals (by mechanical restriction of entry of those chemicals, anoxeamia effect, metabolism deceleration, and augmentation of cell generation cycle), and the terminable anemization is followed by elevation of the blood flow. A regular and long enough anemization increases the base level of skin nutritional support and the skin resistance to adverse factors (anoxaemia, etc.), particularly by increasing a number and lumen of blood vessels feeding the skin, and by rising the efficiency of oxygen utilization in the skin integument (see, for example, http://www.ncbi.nlm nih.gov/pubmed/16710279).

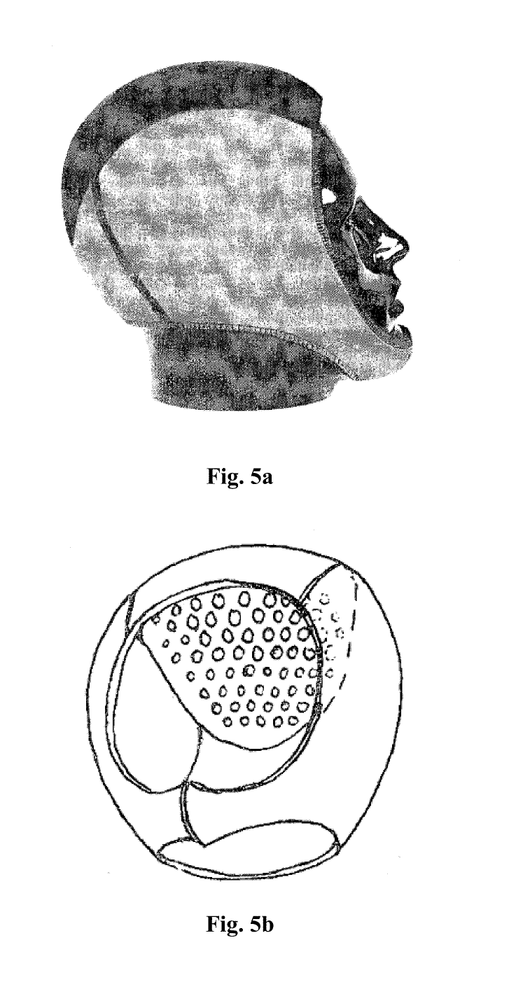

Specifically, the present invention can be used for combating the head skin alopecia. The blood flow through the hair follicles of the balding area is often at the level being inadequate for normal hair growth. Therefore, in order for combating the head skin alopecia, it is possible to take advantage of the device in accordance with the present invention in the form of headdress shown in FIG. 5, where FIG. 5a shows the general view of such a headdress, and FIG. 5b shows a view at the inner space of that headdress. It can be seen in FIG. 5b that the discrete elements in the middle part of their array have a greater size than the discrete elements at the periphery of that array. This is, however, not necessary, and the discrete elements can be both of the same size and of several (more than two) sizes.

After a usual massage of the head skin, the blood flow returns to the initially low level in which the follicles exist all the rest time. Hair has no nutrient reserves, and a good nutrition thereof should be constant. The hair nutrition is firmly improved by an alteration of vasculature induced by a long enough local anoxaemia, which is achieved by a constant anemization of the predetermined skin areas of the scalp during the predetermined time period using the compression headdress with the discrete elements fixed at the inside surface thereof.

Such relief covering allows to decrease several times the force applied to the balding area in order to create the necessary compression (due to the higher specific pressure). When using the compression headdress, a blood flow slows under the relief covering pressed against the scalp skin by an elastic fabric, which stimulates the following (compensatory) intensification of the hair nutrition and activates the growth cells of the hair follicles. Besides the increase of the base level of the hair follicle nutritional support, the device in accordance with the present invention increases the hair follicle resistance to testosterone, anoxaemia and other factors adverse for the hair growth (cross-resistance).

Between other possible applications, a use of the present invention for combating the age-related changes of the facial skin should be noted. In this case, the constant anemization and deformation during a predetermined time period is ensured using a mask applied onto the face, the discrete elements being disposed at the inside surface of that mask. As already noted above, the sizes of those elements could be of millimeters and even deciles of millimeters depending on what specific areas of the facial skin should be effected by those discrete elements. For example, for the delicate skin around eyes, the sizes of those discrete elements must be minimal.

Such mask can be fixed on the face using ties or elastic attachment like carnival mask.

Yet one more application can be the use of the present invention for combating the age-related changes of neck skin. In this case, the constant anemization and deformation during a predetermined time period is ensured using a band applied onto the neck. Such a band from en elastic material is provided with the discrete elements applied, for example, onto the neck skin under a chin. The fixation of that band can be carried out in the same manner as the above described mask, or using clasps of any form.

Yet one more application can be the use of the present invention for combating the lipodystrophical changes of thigh skin. In this case, the constant anemization and deformation during a predetermined time period is ensured using a device in the form of detail of the compression suit put on the thighs. This can be both a separate elastic band and compression trousers, for example, breeches, shorts or leggings.

Yet one more application can be the use of the present invention for combating the age-related changes of hand/arm skin, wherein the constant anemization and deformation during a predetermined time period is ensured using a device in the form of gloves and/or sleevelets put on the hand/arm.

Yet one more application can be the use of the present invention for combating the age-related changes of body skin, wherein the constant anemization and deformation during a predetermined time period is ensured using a device in the form of shirt put on the body.

Thus, the method and device in accordance with the present invention widening the inventory of technical means are sufficiently universal, since they are applicable for use at any skin area and even at a whole body, are very simple in implementation because the constant pressure onto the skin is created exclusively by resilient-elastic features of patch material without use of any additional means.

1. A method for acting on skin integument of living being, which method comprising a step of applying a constant pressure onto respective areas of the skin integument using discrete elements, and that constant pressure ensuring an anematization and deformation of the areas of said skin integument during a predetermined time period, herewith the form, size and surface texture of each of said discrete elements butted against a specific area of said skin integument, as well as a distance between said discrete elements being selected depending on the action required for that specific area of the skin integument, and said predetermined time period and a force of said constant pressure being determined depending on both the specific area of said skin integument and the action required for that area of the skin integument.

2. The method according to claim 1, wherein as said discrete elements being used elements made from a material selected from the group including metals, wood, plastics, silicon, rubber, organic or inorganic minerals.

3. The method according to claim 1, wherein said constant pressure being applied using means selected from the group including: a headdress; a mask applied onto a face; a band applied onto a respective body part; at least one detail of a compression suit put on respective body part.

4. The method according to claim 3, wherein as said detail of the compression suit being used a thing selected from the group including a shirt, trousers, gloves, sleevelets.

5. A device for acting on skin integument of living being, which device comprising discrete elements fixed at the inside surface of patch intended for creating, at respective areas of said skin integument, the constant pressure ensuring an anematization and deformation of said areas of the skin integument during a predetermined time period, herewith the form, size and surface texture of each of said discrete elements butted against a specific area of said skin integument, as well as a distance between said discrete elements being selected depending on the action required for that specific area of the skin integument, and said predetermined time period and a force of said constant pressure being determined depending on both the specific area of said skin integument and the action required for that area of the skin integument.

6. The device according to claim 5, wherein as said discrete elements being used elements made from a material selected from the group including metals, wood, plastics, silicon, rubber, organic or inorganic minerals.

7. The device according to claim 5, wherein said constant pressure being applied using means selected from the group including a headdress; a mask applied onto a face; a band applied onto a respective body part; at least one detail of a compression suit put on respective body part.

8. The device according to claim 7, wherein said detail of the compression suit being a thing selected from the group including a shirt, trousers, gloves, sleevelets.

9. The device according to claim 5, wherein said patch being made from elastic yarns tying said discrete elements each other.

10. The device according to claim 5, wherein said patch being made from a compression knitted fabric.

11. The device according to claim 5, wherein said patch being made from an elastic polymer with said discrete elements fixed thereon.

12. The device according to claim 5, comprising additional discrete elements fixed on the outer surface of said patch.

13. A method for combating the head skin alopecia, which method comprising a step of providing a constant anematization and deformation of the skin during the predetermined time period using the device according to claim 7 made in the form of headdress.

14. A method for combating the age-related changes of facial skin, which method comprising a step of providing a constant anematization and deformation of the skin during the predetermined time period using the device according to claim 7 made in the form of mask applied onto the face.

15. A method for combating the age-related changes of neck skin, which method comprising a step of providing a constant anematization and deformation of the skin during the predetermined time period using the device according to claim 7 made in the form of band applied onto the neck.

16. A method for combating the lipodystrophical changes of thigh skin, which method comprising a step of providing a constant anematization and deformation of the skin during the predetermined time period using the device according to claim 7 made in the form of trousers put on the thighs.

17. A method for combating the age-related changes of hand/arm skin, which method comprising a step of providing a constant anematization and deformation of the skin during the predetermined time period using the device according to claim 7 made in the form of gloves and/or sleevelets put on the arms/hands.

18. A method for combating the age-related changes of body skin, which method comprising a step of providing a constant anematization and deformation of the skin during the predetermined time period using the device according to claim 7 made in the form of shirt put on the body.
